(19) United States
(12) Patent Application Publication
(10) Pub. No.: US 2014/0119177 A1
(43) Pub. Date: May 1, 2014

(54) METHOD AND SYSTEM FOR SELECTIVELY METERING NETWORK TRAFFIC

(71) Applicants: Christopher Nicholas DELREGNO, Basking Ridge, NJ (US); Matthew William TURLINGTON, Richardson, TX (US)

(72) Inventors: Christopher Nicholas DELREGNO, Basking Ridge, NJ (US); Matthew William TURLINGTON, Richardson, TX (US)

(73) Assignee: Verizon Patent and Licensing Inc., Basking, NJ (US)

(21) Appl. No.: 13/665,561

(22) Filed: Oct. 31, 2012

(51) Int. Cl. H04L 12/24

(52) U.S. Cl. 370/229

(57) ABSTRACT

An approach for resizing a network tunnel based on criteria associated with incoming traffic to the network is described. A tunnel management platform determines a frequency or a relevancy of network traffic matching predetermined class of service criteria. The tunnel management platform also calculates, based on the frequency or relevancy, a minimal amount of bandwidth to reserve for tunneling subsequent network traffic associated with the predetermined class of service criteria over a network of the service provider. A resizing of the network tunnel is then initiated based on the calculation in association with subsequent network traffic.

### BACKGROUND INFORMATION

Network providers are continually challenged to deliver value and convenience to consumers by providing compelling services and advancing the underlying technologies. One area of interest has been the development of services and technologies for optimizing the flow of traffic across a network tunnel. Traditionally, network providers employ metering to determine and regulate the influx of traffic conveyed across a network tunnel. By way of example, the metering results can then be used to resize the bandwidth capacity of the network tunnel to accommodate subsequent traffic. Unfortunately, metering is typically performed based on the total amount of traffic entering the tunnel without regard to the class of service of the traffic or other configurable criteria. This results in the allocation of more network bandwidth than is required, thereby impeding the efficiency of the network.

Based on the foregoing, there is a need for resizing a network tunnel based on criteria associated with incoming traffic to the network.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system for resizing a network tunnel based on criteria associated with incoming traffic to the network, according to one embodiment;

FIG. 2 is a diagram of a tunnel management platform, according to one embodiment;

FIGS. 3A-3D are flowcharts of processes for resizing a network tunnel based on criteria associated with incoming traffic to the network, according to various embodiments;

FIGS. 4A and 4B are diagrams of a user interface for resizing a network tunnel based on criteria associated with incoming traffic to the network, according to various embodiments;

FIG. 5 is a diagram of a computer system that can be used to implement various exemplary embodiments; and

FIG. 6 is a diagram of a chip set that can be used to implement an embodiment of the invention.

### DESCRIPTION OF THE PREFERRED EMBODIMENT

An apparatus, method and software for resizing a network tunnel based on criteria associated with incoming traffic to the network are described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

Although the various exemplary embodiments are described with respect to metering of a network tunnel, it is contemplated these embodiments have applicability to any data protocols, communication paths, methodologies or systems for managing the resources of a network or any other types of resources and/or infrastructures.

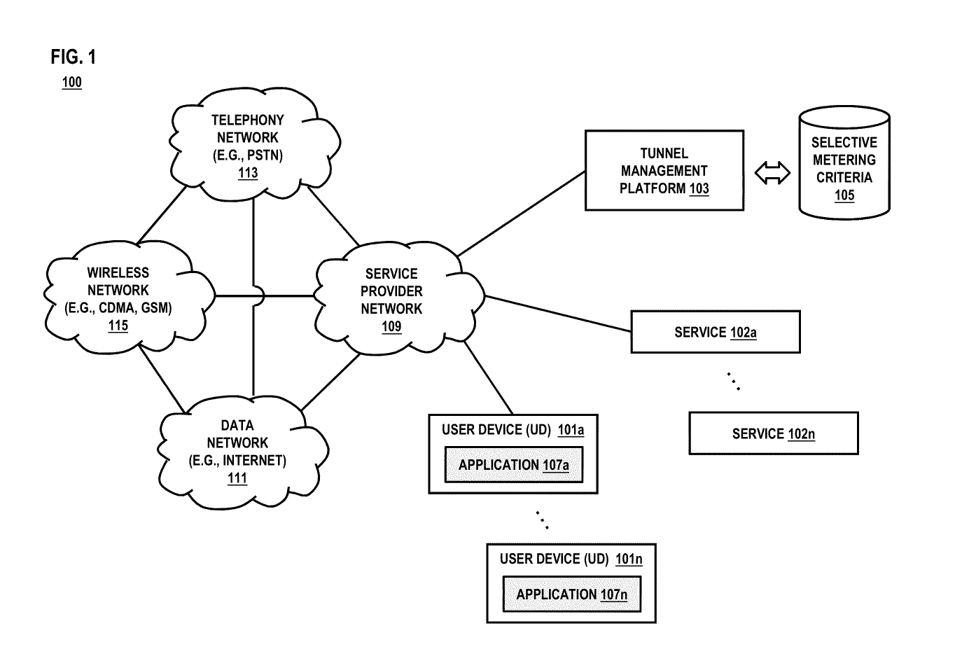

FIG. 1 is a diagram of a system for resizing a network tunnel based on criteria associated with incoming traffic to the network, according to one embodiment. For the purpose of explanation, system 100 is shown to include one or more user devices 101a-101n (e.g., mobile device, smart phone, netbook, laptop, set-top box, or any communications enabled computing device), referred to herein collectively as user devices 101. Also, system 100 is shown to include one or more services 102a-102n (e.g., social networking service, content service, server platform), referred to herein collectively as services 102. The user devices 101 and/or services 102 may be configured to access a network, i.e., service provider network 109, as maintained by a network provider. One or more tunnels may be established in connection with service and/or data transmission requests initiated by said user devices 101 and/or services 102 via the service provider network 109. Although certain embodiments are described with respect to tunnels, it is contemplated that the approach described herein is applicable to communication paths in general.

As mentioned previously, network providers often employ network tunneling techniques for supporting the transmission of data of varying types (e.g., traffic) across their network. By way of example, a network tunnel is a type of dedicated connection established via an encapsulation or tunneling protocol, such as Layer 2 Tunneling Protocol (L2TP), Point-to-Point Tunneling Protocol (PPTP), Secure Shell (SSH), Multiprotocol Label Switching Label Switched Paths (MPLS LSPs) or the like. Typically, the tunnel is established by way of a procedure wherein one network protocol (the delivery protocol at the client) encapsulates a different payload protocol for accessing a network server/gateway. The connection is established to facilitate data transmission requests initiated by devices 101 and/or services 102, including those requiring data security and/or for enabling data sharing across different networks. Of note, one or more tunnels may be established via the service provider network 109 to facilitate transmission of traffic for multiple different user devices 101 and/or services 102.

In general, tunnels must be large enough to ensure the proper flow of data of varying types, protocols and payloads. For this reason, network providers periodically adjust the size, i.e., bandwidth capacity, of a network tunnel to optimize the flow of traffic across the network 109. Typically, implementations of automatic tunnel resizing mechanisms can be driven by formal Call (or Connection) Admission Control (CAC) of traffic into the tunnel, metering of the traffic entering the tunnel or a combination of both.

In the case of metering, the total amount of traffic entering a tunnel is the primary criteria for determining how a tunnel is to be resized. For example, when a bulk, aggregate metering result is provided as input to a resizing scheme/algorithm, this results in the reservation of more bandwidth capacity than required in an effort to accommodate traffic payloads of higher classes of service (e.g., real-time data). Consequently, the resulting over expenditure of bandwidth capacity impedes the overall efficiency of the network. Unfortunately, there is no convenient solution for enabling a network tunnel to be automatically resized based on customizable, network provider specified criteria.

To address this issue, system 100 presents a tunnel management platform 103 that is configured to initiate resizing of a network tunnel based on selective metering criteria. Still further, the tunnel management platform 103 enables a weighting factor to be applied for establishing a priority or relevancy of incoming traffic based on the criteria. In certain embodiments, the criterion is established by the network provider and configured for execution by the tunnel management platform 103 in connection with a bandwidth allocation or tunnel resizing scheme. By way of this approach, the tunnel management platform 103 enables the bandwidth reservation requirements of a network 109 to be managed based on configurable parameters (e.g., by the network provider).

In certain embodiments, the tunnel management platform 103 maintains a criteria database 105 for performing selective metering of a network tunnel. For the purpose of illustration, selective metering pertains to any means of monitoring and/or regulating the influx of traffic conveyed over a network tunnel based on one or more network provider selected criteria and/or parameters. The network traffic may include any number and arrangement of data packets generated, via a communication/network protocol, for transporting a payload across a network (e.g., a service provider network 109). The criteria may specify one or more rules, instructions or requirements for initiating the metering process based on fulfillment of one or more conditions.

By way of example, the metering criteria may be generated to specify a class of service type associated with incoming traffic. The class of service type may indicate a specific category of incoming data packets being transmitted across a network tunnel and/or may indicate the relevancy of said packets. Under this scenario, the network provider may assign a real-time class of service type to any data required to facilitate real-time executions, such as video, internet telephony, multimedia or audio. Alternatively, a best effort class of service type may indicate traffic that is to be transmitted over the network tunnel only after transmission of higher priority data (if at all).

As another example, the class of service type may be assigned by the network provider via the metering criteria to indicate a business category of incoming data packets. Under this scenario, a priority business class may indicate a heightened urgency of incoming traffic (e.g., corporate or government data) while a standard business class may be assigned to data of a lesser urgency (e.g., non-corporate or public data). Still further, the class of service type may be associated with a specific customer size, account level, account type or subscription level, wherein traffic transmitted by certain customers or network subscription classes takes precedence over others. It is noted that historical data regarding the customer, registered account settings or subscription information may be accounted for in determining assignment of a business class of service type.

The class of service type may also be defined by the network provider via criteria in relation to a particular protocol used to formulate the traffic and encapsulate the payload data. Under this scenario, a class of service designation may be encapsulated within a designated data field or header of an incoming data packet. Hence, in the case of a packet switched network, a 3-bit class of service (CoS) field may be present in an Ethernet frame header when 802.1Q virtual local area network (VLAN) tagging is present. The field may specify a priority value or class, such as in the case of a differentiated services code point (DSCP). It is noted that other classification mechanisms may also be employed according to different quality of service (QoS) disciplines and architectures accordingly. It is also noted that the class of service type may be appended to incoming data packets as metadata or as one or more tags.

As another example, the class of service type may be defined by the network provider via the selective metering criteria to correspond to a port connection type or level. The port type may be a classification of the type of end-to-end connection to formulate across a network. Under this scenario, the port type may be specified as a numeric value corresponding to a particular network protocol, i.e., Transmission Control Protocol (TCP), User Datagram Protocol (UDP), Stream Control Transmission Protocol (SCTP) or Datagram Congestion Control Protocol (DCCP). The port type may also specify a different connection speed for facilitating end-to-end transmission of traffic, i.e., T1 (1.533 Mbps), Fast Ethernet (100M), Gigabit Ethernet (1000M), etc. Still further, the port type may be defined per the criteria as a dedicated port, a private port, a virtual port or dynamic port.

Still further, the class of service type may be defined by the network provider via the metering criteria based on oversubscription requirements associated with incoming traffic as specified by the network provider. By way of example, the oversubscription requirements may refer to the allocation of a minimum (guaranteed) amount of bandwidth capacity to be reserved by the network provider for accommodating different connection types and/or customers. Under this scenario, the network provider may specify a first oversubscription class as corresponding to a first level/percentage of oversubscription for a given port, while a second oversubscription class may correspond to a second level of oversubscription for the port.

In certain embodiments, the network provider may access a configuration interface of the tunnel management platform 103 for defining the selective metering criteria. The configuration interface may be presented by way of an application 107 (e.g., browser) of a user device 101. Under this scenario, the network provider may specify a particular class of service type and/or associated conditions for defining a set of metering criteria in association with incoming traffic. In addition, the network provider may specify one or more parameters of incoming traffic to enable cross-referencing of the traffic against the criteria. For example, the parameter may include a marking or identifier (e.g., customer identifier, account identifier) within a data field for enabling further identification of incoming traffic relative to the criteria.

It is noted by way of the above described examples that the selective metering criteria may be generated and/or customized by the network provider to account for different types and classes of traffic. In addition, the criteria are also established to account for the different connection fulfillment/tunnel establishment needs of the network provider. Each of the above described class of service types may also be correlated with a designated bandwidth capacity.

In certain embodiments, the tunnel management platform 103 samples incoming traffic to a network tunnel during a sampling period. The sampling period may be designated by the network provider as a duration of time (e.g., a number of minutes) for metering the network based on established criteria. During the sampling period, for example, the network tunnel compares the incoming network traffic against the class of service criteria to determine whether any of the traffic conforms to a specific class of service type. By way of example, the tunnel management platform 103 may identify a class of service identifier in association with incoming traffic, wherein the identifier matches the criteria.

As another example, the tunnel management platform 103 may identify a port type identifier for determining a match between the identifier and the established criteria. During sampling, the tunnel management platform 103 also determines the total amount of traffic entered onto a tunnel overall and/or by class of service type. The tunnel management platform 103 then stores the compiled results to a database for subsequent analysis. It is noted that the sampling period may be performed periodically or on demand by the network provider.

Upon completion of the sampling period, the tunnel management platform 103 analyzes the results to determine a frequency or relevancy of certain class of service types. By way of example, the tunnel management platform 103 may present, via a reporting interface, statistics for indicating which class of service type is most prevalent. In addition, the reporting interface may indicate which parameters associated with incoming network traffic are frequently recurring and at what corresponding amount of bandwidth. Based on the determined patterns of traffic per the sampling period, the network tunnel management platform 103 then calculates a minimal amount of bandwidth required to be reserved for tunneling subsequent network traffic. The minimal amount of bandwidth refers to an optimal amount of bandwidth to be allocated to a tunnel for accommodating subsequent traffic conforming to same patterns or bandwidth sizing requirements. Of note, the minimal amount of bandwidth represents a value that is less than an aggregate value determined strictly on the basis of all incoming class types.

In certain embodiments, the tunnel management platform 103 initiates execution of a bandwidth resizing algorithm or scheme based on the determined minimal (optimal) bandwidth calculation. The bandwidth resizing algorithm or scheme may include one or more instructions for automatically adapting the capacity of an established network tunnel. By way of example, the scheme may be a bandwidth throttling scheme, traffic shaping scheme or a combination thereof. Moreover, the algorithm or scheme may be based on a resource reservation protocol (RSVP), a constraint-based routing label distribution protocol (CR-LDP), a top-nodes algorithm, or a combination thereof. Any known or developing bandwidth resizing algorithms or schemes may be applied.

For the purpose of illustration, an exemplary use case is presented for enabling metering and subsequent network tunnel resizing to be performed based on selectively configured class of service criteria (referred to herein as selective metering). Under this scenario, the tunnel management platform 103 determines that incoming traffic correlated to eight specified classes, i.e., via a Class of Service (CoS) marking. Per the analysis, the following is observed: Class 7=10 Mbps, Class 6=100 Mbps, Class 5=50 Mbps, Class 4=10 Mbps, Class 3=100 Mbps, Class 2=0 Mbps, Class 1=100 Mbps and Class 0=500 Mbps. An aggregate metered rate of 870 Mbps is determined along with a determined relevancy or frequency of Class 5 and Class 3.

The tunnel management platform 103 determines a minimal amount of bandwidth to reserve for establishing a tunnel based on the results. For example, as it is determined that only 150 Mbps of reserved bandwidth is required for the most relevant classes (Class 5 and Class 3), the tunnel management platform 103 initiates a bandwidth tunnel algorithm/scheme for sizing the tunnel to accommodate 150 Mbps of traffic. This represents a greater than 82% reduction in the amount of bandwidth to be reserved versus the aggregate metered rate of 870 Mbps. It is noted that any combination of classes could be used to determine the appropriate bandwidth reservation.

In certain embodiments, the relevancy or frequency of a given class of service type may be designated by the network provider by way of a weighting factor. The weighting factor may be a configurable weight (expressed as a percentage) that can be assigned to each class for performing metering of a network tunnel. Under this approach, the network provider is able to designate specific class of service types as higher priority or more relevant than others regardless of the determined results of the sampling period; thus enabling certain class of service types to override others automatically. By way of example, the weighting factor may be assigned via the configuration interface generated by the tunnel management platform 103 and associated with a corresponding class of service type via the criteria. As such, additional tunnel resizing results may be achieved.

For the purpose of illustration, an exemplary use case is presented for enabling metering and subsequent network tunnel resizing to be performed based on a weighting factor associated with the class of service criteria (referred to as weighted metering). In the previous example, a metered bandwidth of 150 Mbps was calculated as the minimal (optimal) amount needed to be reserved for a tunnel via a bandwidth resizing scheme. However, under this scenario, Class 5 represents a real-time voice class of service, where no oversubscription is allowed, while Class 3 is a lower, bursty class of service wherein only half of the metered bandwidth is needed to drive tunnel bandwidth reservations (increased oversubscription). The network provider may specify a weighting factor for each class to accommodate these requirements.

In this example, Class 5 is assigned a weight of 100% whereas Class 3 is assigned a weight of 50%. All other class of service types are then assigned a weight of 0%. The resultant metered traffic value is 100 Mbps, with 50 Mbps assigned to Class 5 (e.g., 50 Mbps×100%) and 50 Mbps for Class 3 (e.g., 100 Mbps×50%). This is in contrast to the 150 Mbps associated with the selective metering approach described above, thus representing a further reduction in the reservation requirement versus the aggregate metering approach. As before, any combination of classes and associated weights can be used to determine the appropriate bandwidth reservation. Also, the tunnel management platform 103 may be configured to enable application of a weighting factor and network provider defined class of service types concurrently for facilitating metering of a network tunnel.

It is noted that the tunnel management platform 103 may be implemented as a system and/or network agnostic platform. As such, the platform 103 may be configured to account for cross-system or cross-network class of service types and configurations, i.e., based on the specified selective metering criteria. Moreover, the tunnel management platform 103 may be configured to identify and respond to traffic originating from or transmitted across the networks of different network providers.

The criteria may also be established and/or customized by the provider for enabling the platform 103 to respond to traffic generated in accordance with different protocols and/or payload encapsulation requirements. Still further, the criteria may be generated to account for network devices, including arrays, routers (e.g., label switch routers), switches, etc., conforming to different vendor and/or manufacturer requirements.

It is noted that user devices 101a-101n may be any type of mobile terminal, fixed terminal, or portable terminal including a mobile handset, station, unit, device, multimedia computer, multimedia tablet, Internet node, communicator, desktop computer, laptop computer, Personal Digital Assistants (PDAs), smartphone or any combination thereof. It is also contemplated that the UDs 101a-101n can support any type of interface for supporting the presentment or exchanging of data. In addition, user devices 101a-101n may facilitate various input means for receiving and generating information, including touch screen capability, keyboard and keypad data entry, voice-based input mechanisms and the like. Any known and future implementations of user devices 101 are applicable. From the perspective of a customer, the user devices 101 may initiate transmission of data across a network tunnel. From the perspective of a network provider, the user devices 101 facilitate access to the tunnel management platform 103.

In certain embodiments, user devices 101a-101n, the tunnel management platform 103 and other elements of system 100 may be configured to communicate via a service provider network 109. According to certain embodiments, one or more networks, such as data network 111, telephony network 113, and/or wireless network 115, can interact with the service provider network 109. Networks 109-115 may be any suitable wireline and/or wireless network, and be managed by one or more providers. For example, telephony network 113 may include a circuit-switched network, such as the public switched telephone network (PSTN), an integrated services digital network (ISDN), a private branch exchange (PBX), or other like network. Wireless network 115 may employ various technologies including, for example, code division multiple access (CDMA), long term evolution (LTE), enhanced data rates for global evolution (EDGE), general packet radio service (GPRS), mobile ad hoc network (MANET), global system for mobile communications (GSM), Internet protocol multimedia subsystem (IMS), universal mobile telecommunications system (UMTS), etc., as well as any other suitable wireless medium, e.g., microwave access (WiMAX), wireless fidelity (WiFi), satellite, and the like. Meanwhile, data network 111 may be any local area network (LAN), metropolitan area network (MAN), wide area network (WAN), the Internet, or any other suitable packet-switched network, such as a commercially owned, proprietary packet-switched network, such as a proprietary cable or fiber-optic network.

Although depicted as separate entities, networks 109-115 may be completely or partially contained within one another, or may embody one or more of the aforementioned infrastructures. For instance, service provider network 109 may embody circuit-switched and/or packet-switched networks that include facilities to provide for transport of circuit-switched and/or packet-based communications. It is further contemplated that networks 109-115 may include components and facilities to provide for signaling and/or bearer communications between the various components or facilities of system 100. In this manner, networks 109-115 may embody or include portions of a signaling system 7 (SS7) network, Internet protocol multimedia subsystem (IMS), or other suitable infrastructure to support control and signaling functions.

According to exemplary embodiments, end user devices (not shown) may be utilized to communicate over system 100 and may include any customer premise equipment (CPE) capable of sending and/or receiving information over one or more of networks 109-115. For instance, voice terminal may be any suitable plain old telephone service (POTS) device, facsimile machine, etc., whereas mobile device (or terminal) may be any cellular phone, radiophone, satellite phone, smart phone, wireless phone, or any other suitable mobile device, such as a personal digital assistant (PDA), pocket personal computer, tablet, customized hardware, etc. Further, computing device may be any suitable computing device, such as a VoIP phone, skinny client control protocol (SCCP) phone, session initiation protocol (SIP) phone, IP phone, personal computer, softphone, workstation, terminal, server, etc.

It is noted, though not shown in the figure, that in certain embodiments user devices 101a-101n may be configured to establish peer-to-peer communication sessions with each other using a variety of technologies—near field communication (NFC), Bluetooth, ZigBee, infrared, etc. Also, connectivity can be provided via a wireless local area network (LAN). By way of example, a group of user devices 101a-101n may be configured to a common LAN so that each device can be uniquely identified via any suitable network addressing scheme. For example, the LAN may utilize the dynamic host configuration protocol (DHCP) to dynamically assign “private” DHCP internet protocol (IP) addresses to each user device 101, i.e., IP addresses that are accessible to devices connected to the service provider network 109 as facilitated via a router.

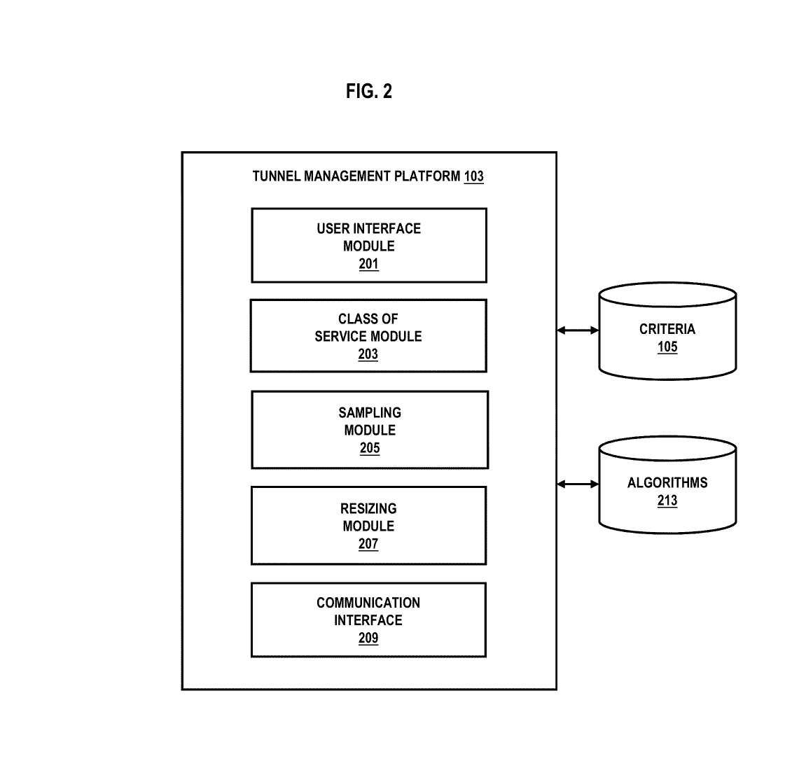

FIG. 2 is a diagram of a tunnel management platform, according to one embodiment. The tunnel management platform 103 includes various executable modules for performing one or more computing, data processing and network based instructions that in combination provide a means of resizing a network tunnel. Such modules can be implemented in hardware, firmware, software, or a combination thereof. By way of example, the tunnel management platform 103 may include a class of service module 203, resizing module 207, sampling module 205, user interface module 201 and a communication interface 209.

In addition, the tunnel management platform 103 also accesses one or more bandwidth resizing algorithms from a database 213 and class of service criteria from a database 105. It is noted that modules 201-209 may access databases 105 and 213 for performing various functions.

In one embodiment, the user interface module 201 enables presentment of a graphical user interface or command line interface for enabling network provider access to the tunnel management platform 103. This includes, for example, accessing of a configuration interface for enabling the user to select or directly specify criteria for defining various class of service types to associate with incoming traffic. In addition, the user interface module 201 may facilitate generation of a reporting interface for indicating the frequency and/or relevancy of network traffic metered through a tunnel during a sampling period executed via the sampling module 205. By way of example, the user interface module 201 generates interfaces in response to application programming interfaces (APIs) or other function calls corresponding to an application 107 of user devices 101 of a network provider; thus enabling the display of graphics primitives.

It is noted that the user interface module 201 may also operate in connection with a sampling module 205 for enabling execution of a sampling interface. By way of example, the sampling interface may be configured to generate one or more user interface elements for defining a duration of the sampling period. In addition, the sampling interface may feature an action button for initiating execution of the sampling module 205, thus enabling storing of the results from metering of incoming data packets based on the criteria. Also, the sampling interface may operate in connection with or as a reporting interface for presenting the results of the metering execution.

In one embodiment, the class of service module 203 determines whether network traffic metered during a sampling period matches predetermined criteria established by the network provider. The class of service module 203 enables various data and/or elements of incoming traffic to be cross referenced against the defined criteria for determining a correlation between the traffic and a class of service type. By way of example, the class of service module 203 identifies a marking, a tag or other data associated with incoming packets for specifying or identifying a class of service type for the traffic. Alternatively, in the case of explicit specification of class of service information within a packet, the module 203 may parse incoming packets to determine a class of service type.

It is noted that the cross referencing of criteria with information in the packet may include, for example, determining a source IP address associated with incoming traffic, determining a customer identifier associated with incoming traffic, or the like. In the case of the IP address for instance, the class of service module 203 may cross reference the IP address against network registration information to determine a corporate domain/user. Based on this, the class of service module 203 may further associate the IP address with a business class of service type (e.g., priority class) based on identification of traffic originating from the customer.

The class of service module 203 also determines a minimal (optimal) bandwidth to assign (for reservation) to traffic of a given class of service type. By way of example, the class of service module 203 receives the results—i.e., the sampling of traffic transmitted via a tunnel—as compiled by the sampling module 205 during a sampling period. In addition, the class of service module 203 determines a weighting factor to be applied to traffic conforming to the criteria. By way of example, the weighting factor may be expressly specified by a network provider via a configuration interface, with the input being passed to the class of service module 203 for affecting a prioritization/weighting of different traffic types to a tunnel.

In one embodiment, the sampling module 205 initiates a sampling period at the discretion of the network provider. By way of example, the sampling module 205 may operate in connection with the user interface module 201 to facilitate network provider access to the platform 103 for performing sampling. It is noted that the sampling may be performed in association with one or more metering schemes.

Once executed, the sampling module 205 stores metering results gathered during the sampling period as well as tabulates the bandwidth of incoming traffic per the determined class of service type. In this case, the bandwidth may be determined for each individual class of service type identified via the criteria or based on the aggregate of traffic to the tunnel. The results may be further analyzed by the sampling module 205 to determine a relevancy or frequency of certain types of traffic per defined class of service type. This calculation is performed to enable the network provider to comprehend patterns of network traffic entering a tunnel and includes determining a minimal (optimal) bandwidth value to associate with each class of service type.

In one embodiment, the resizing module 207 initiates resizing of a network tunnel based on the determined minimal (optimal) bandwidth value for the respective class of service types observed over the network. By way of example, the minimal bandwidth value is passed to the resizing module 207 by the sampling module 205 for establishing an amount of bandwidth to associate with certain types of traffic. Still further, the resizing module 207 may apply a weighting factor to specific class of service types as submitted via a configuration interface of the user interface module 201. Resultantly, the bandwidth resizing algorithm 213 or scheme may include one or more instructions for automatically adapting or setting the allotted bandwidth capacity of a network tunnel based on the weight, the minimal bandwidth value, specific class of service types, or a combination thereof

In one embodiment, a communication interface 209 enables formation of a session over a network 109 between the tunnel management platform 103 and a user device 101 of a network provider. By way of example, the communication interface 209 executes various protocols and data sharing techniques for enabling collaborative execution between a subscriber's user device 101 (e.g., mobile devices, laptops, smartphones, tablet computers, desktop computers) and the tunnel management platform 103 over the network 109. It is noted the communication interface 209 is also configured to support a browser session—i.e., the retrieval of content as referenced by a resource identifier for accessing various interfaces generated by the user interface module 201.

Also, while not shown, various monitoring systems may be accessed by the tunnel management platform 103 for detecting current data traffic levels, error conditions, data exchange rates, network latencies, resource allocation levels and other conditions associated with the operation of the service provider network 109. It is noted that the monitoring systems may provide feedback data to the resizing module 207 for further affecting resizing of a network tunnel.

The above presented modules and components of the tunnel management platform 103 can be implemented in hardware, firmware, software, or a combination thereof. Though depicted as a separate entity in FIG. 1, it is contemplated that the tunnel management platform 103 may be implemented for direct operation by respective UE 101 of a network provider. As such, the platform 103 may generate direct signal inputs by way of the operating system of the UE 101 for interacting with the application 107 as well as for monitoring various devices/systems within the service provider network 109. In another embodiment, one or more of the modules 201-209 may be implemented for operation by respective UE 101 as a platform 103.

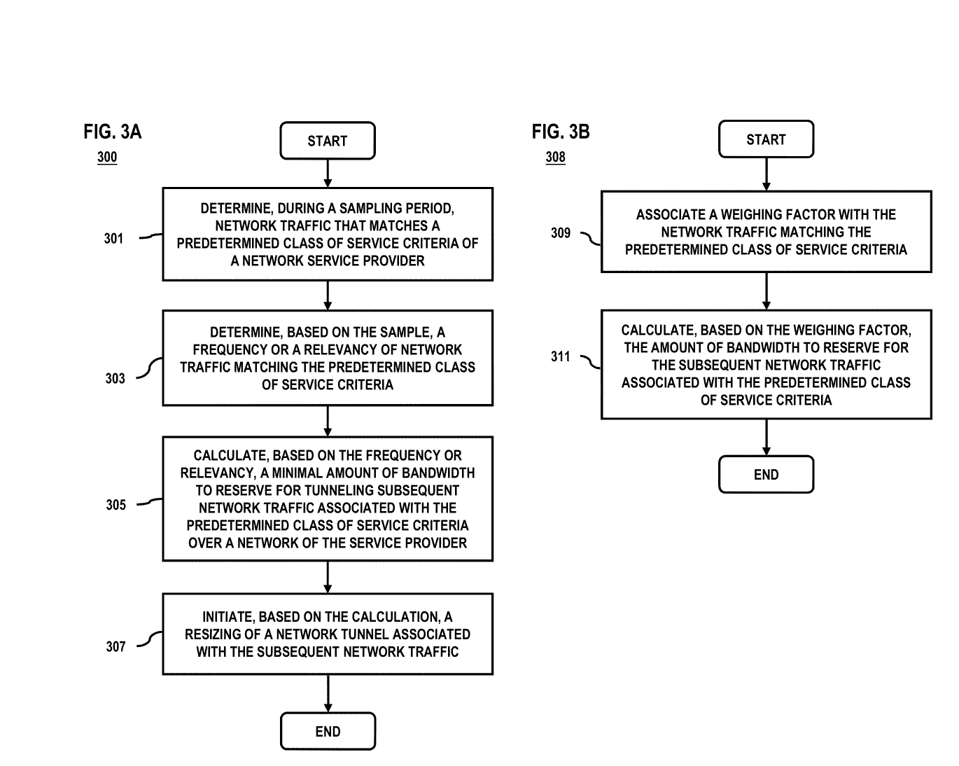

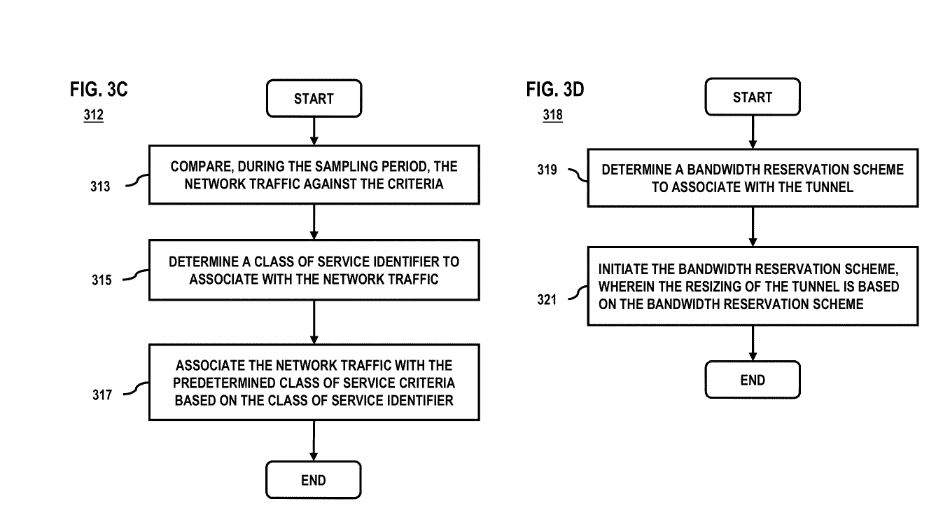

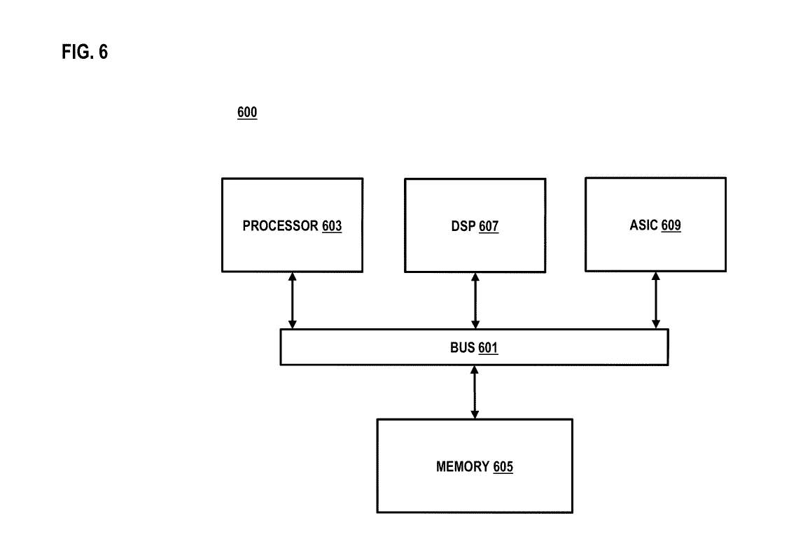

FIGS. 3A-3C are flowcharts of processes for resizing a network tunnel based on criteria associated with incoming traffic to the network, according to various embodiments. In one embodiment, the tunnel management platform 103 performs the process 300 and is implemented in, for instance, a chip set including a processor and a memory as shown in FIG. 6.

In step 301 of process 300 (FIG. 3A), the tunnel management platform 103 determines, during a sampling period, network traffic that matches a predetermined class of service criteria of a network provider. In another step 303, the platform 103 determines, based on the sample, a frequency or a relevancy of network traffic matching the predetermined class of service criteria. The frequency or relevancy may be based on a pattern of incoming traffic to the network tunnel during the sampling period. As noted previously, the criteria may define various class of service types for enabling identification of incoming traffic.

In another step 305, the tunnel management platform 103 calculates, based on the frequency or relevancy, a minimal amount of bandwidth to reserve for tunneling subsequent network traffic associated with the predetermined class of service criteria over a network of the network provider. As noted previously, the minimal amount of bandwidth pertains to an amount required based on the observed traffic patterns/history rather than an aggregate amount based on the entry and transmission of all traffic to a network tunnel. Per step 307, the platform 103 also initiates, based on the calculation, a resizing of a network tunnel associated with the subsequent network traffic. Of note, the subsequent network traffic may include that received to the tunnel outside of the sampling period.

In step 309 of process 308 (FIG. 3B), the tunnel management platform 103 associates a weighting factor with the network traffic matching the predetermined class of service criteria. Per step 311, the platform 103 calculates, based on the weighting factor, the amount of bandwidth to reserve for the subsequent network traffic associated with the predetermined class of service criteria. As noted previously, the weighting factor may be assigned by a network provider to directly indicate a relevancy or priority of traffic of one class of service type versus another.

In step 313 of process 312 (FIG. 3C), the tunnel management platform 103 compares, during the sampling period, the network traffic against the criteria. In another step 315, the platform 103 determines a class of service identifier to associate with the network traffic. As mentioned before, the class of service identifier may be a data field of a packet corresponding to incoming traffic. Alternatively, the identifier may be expressed in the form of metadata or a tag associated with incoming traffic. Per step 317, the platform 103 associates the network traffic with the predetermined class of service criteria based on the class of service identifier.

In step 319 of process 318 (FIG. 3D), the tunnel management platform 103 determines a bandwidth reservation scheme to associate with the tunnel. Per step 321, the platform 103 also initiates the bandwidth reservation scheme. Of note, the algorithm associated with the scheme regulates the bandwidth allocation according to the minimal amount of bandwidth determined to be reserved per step 305 of process 300 (FIG. 3A).

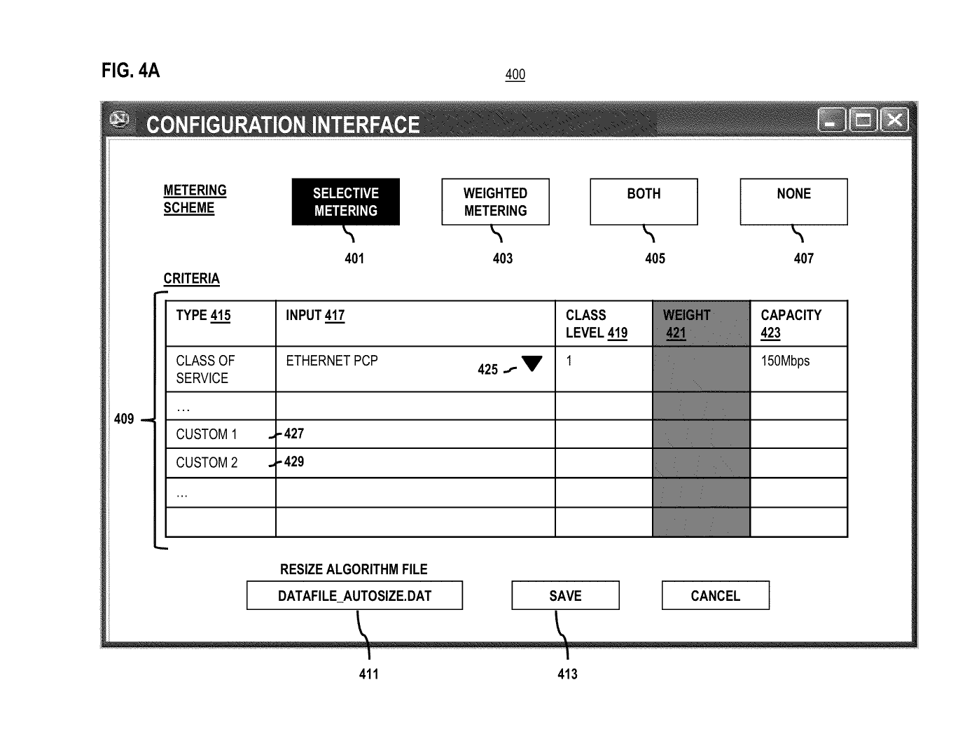

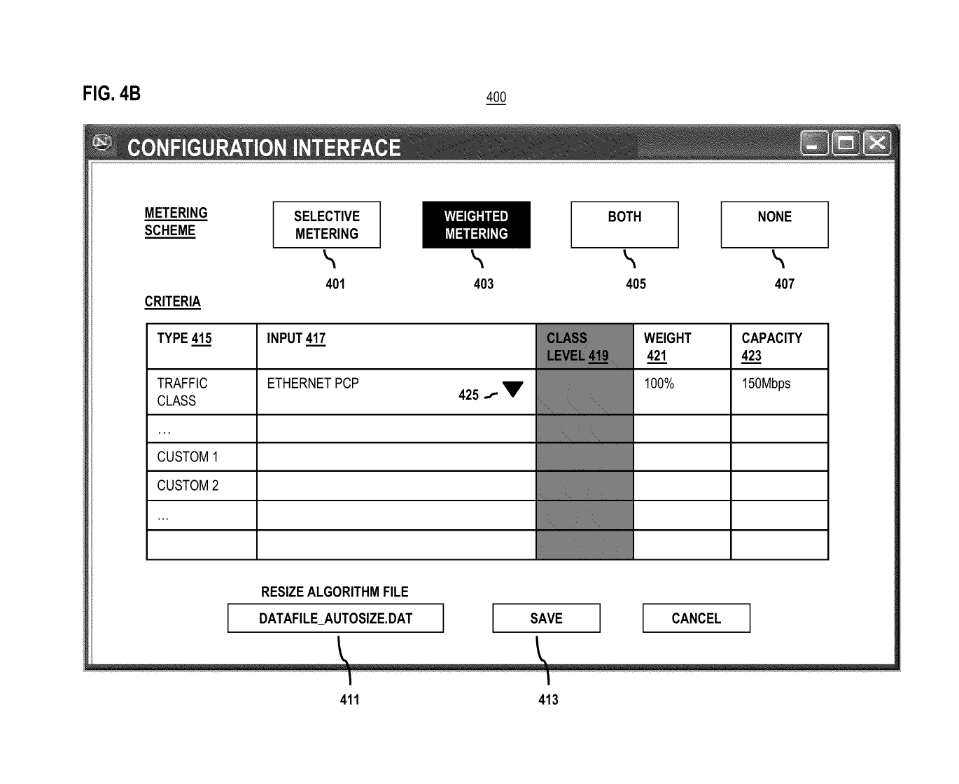

FIGS. 4A and 4B are diagrams of a user interface for resizing a network tunnel based on criteria associated with incoming traffic to the network, according to various embodiments. For the purpose of illustration, the diagrams are described with respect to an exemplary use case of a configuration interface 400 as accessed by a network provider. Under this scenario, a user of the configuration interface may be a person having administrative authority granted by the network provider. It is noted that while the user interface depictions correspond to the process of resizing a network tunnel, the devices may be configured to cause presentment of various additional screens based on interaction of devices with the platform 103.

In FIG. 4A, the configuration interface 400 presents various user interface elements for permitting the user to influence operation of the tunnel management platform 103. By way of example, various metering scheme selection options are presented for enabling the user to specify a metering mode of operation to execute. This includes a “selective metering” action button 401 for initiating metering of incoming network traffic based criteria selected by or established by the network provider. The user is also presented with a “weighted metering” action button 403 for initiating metering of incoming network traffic based on a weighting factor associated with different class of service types. Also presented is a “both” action button 405 for enabling metering of traffic based on a class of service type and applied weight. Still further, a “none” action button 407 is presented for employing standard aggregated bandwidth metering or the like.

In this example, when the user selects the “selective metering” action button 401, a table 409 for permitting user customization, entry or selection of criteria is active. The table may include, for example, columns for defining variables and/or parameters for performing metering of traffic. For example, a type column 415 features cells for enabling the user to define a type of parameter to be identified and/or associated as class of service established criteria. Under this scenario, the cells may be populated by the platform 103 to specify a class of service type, while other cells (e.g., 427 and 429) may be customized by the user. For example, the user may define the type according to the requirements or jargon of the network provider.

Column 417 features cells for enabling a user to select via a menu button 425 class of service types to be classified/observed during the sampling period. By way of example, the user may select from a class of service type menu of Ethernet (Priority Code Point) PCP for designating this particular traffic type. The user may also select other defined classes, including IP Type of Service (TOS), Differentiated Services Code Point (DSCP) Class Selector, DSCP, Multiprotocol Label Switching (MPLS) Experiential, MPLS Traffic Class, IPV6 Traffic Class, etc. Alternatively, the user can manually provide the input via a keyboard or other data entry means.

Upon selection or entry, a class level 419 associated with the type may be populated. For example, IPV6 related traffic may be assigned to Class 6 depending on the transmission request while MPLS related traffic may be assigned to Class 7. Assignments may be customized by the user or per a standard classification system. Table 2, for example, depicts the different classes of service for the 3-bit PCP data field of a packet per the IEEE 802.1Q-2005 specification header. It is noted, however, that the way traffic is handled when assigned to any particular class is undefined.

TABLE 2

| PCP | Network priority | Acronym | Traffic characteristics |
|---|---|---|---|
| 1 | 0 (lowest) | BK | Background |
| 0 | 1 | BE | Best Effort |
| 2 | 2 | EE | Excellent Effort |
| 3 | 3 | CA | Critical Applications |
| 4 | 4 | VI | Video, <100 ms latency |
| 5 | 5 | VO | Voice, <10 ms latency |
| 6 | 6 | IC | Internetwork Control |
| 7 | 7 (highest) | NC | Network Control |

Also presented via column 432 are various cells for indicating a bandwidth capacity to associate with a selected/defined class of service type. The bandwidth capacity may be established by the user or based on known standards associated with specific class types. It is noted that for this scenario, the weight column 421 is masked out to prevent entry of a weighting factor per the selective metering mode of operation.

The user is also presented with a data entry field 411 for specifying a bandwidth reservation and/or resizing algorithm to associate with the metering operation. By way of example, the bandwidth reservation and/or resizing algorithm may be used to process the results collected during sampling of network traffic per selective metering of the traffic. Also presented is a save action button 413 for permitting the user to store the criteria established via the table 409 to a data file. This data file may be used for cross referencing of subsequent network traffic transmitted via a tunnel against the established criteria.

In FIG. 4B, when the user selects the “weighted metering” action button 403, the weight column 421 of the criteria table 409 is unmasked to permit user entry of a weighting factor for a defined class of service type. In contrast, the class level 419 is masked to prevent defining of a class level for affecting prioritization of the specified class of service type. Under this scenario, the user applies a weighting factor to each specified input 417 for defining a class of service type. For example, the weight may be expressed as a percentage value for representing the level of relevance or priority of the assigned input 417 and/or type 415.

The exemplary techniques and systems presented herein enables resizing of a network tunnel to be driven based on the fulfillment of criteria established by a network provided. Still further, the exemplary techniques and systems herein enable a weight to be expressly applied as a means of prioritizing incoming traffic conforming to the established criteria. The technique permits network providers to minimize the amount of bandwidth reserved for handling traffic transmitted over a network tunnel for increasing overall network efficiency.

The processes described herein for resizing a network tunnel based on criteria associated with incoming traffic to the network may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

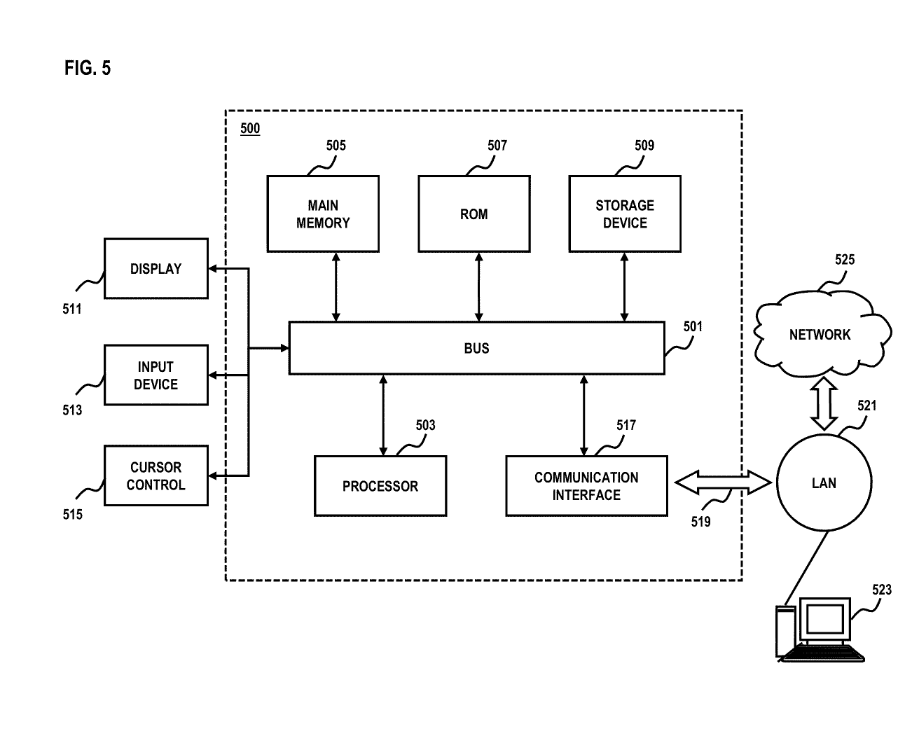

FIG. 5 is a diagram of a computer system that can be used to implement various exemplary embodiments. The computer system 500 includes a bus 501 or other communication mechanism for communicating information and one or more processors (of which one is shown) 503 coupled to the bus 501 for processing information. The computer system 500 also includes main memory 505, such as a random access memory (RAM) or other dynamic storage device, coupled to the bus 501 for storing information and instructions to be executed by the processor 503. Main memory 505 can also be used for storing temporary variables or other intermediate information during execution of instructions by the processor 503. The computer system 500 may further include a read only memory (ROM) 507 or other static storage device coupled to the bus 501 for storing static information and instructions for the processor 503. A storage device 509, such as a magnetic disk or optical disk, is coupled to the bus 501 for persistently storing information and instructions.

The computer system 500 may be coupled via the bus 501 to a display 511, such as a cathode ray tube (CRT), liquid crystal display, active matrix display, or plasma display, for displaying information to a computer user. An input device 513, such as a keyboard including alphanumeric and other keys, is coupled to the bus 501 for communicating information and command selections to the processor 503. Another type of user input device is a cursor control 515, such as a mouse, a trackball, or cursor direction keys, for communicating direction information and command selections to the processor 503 and for adjusting cursor movement on the display 511.

According to an embodiment of the invention, the processes described herein are performed by the computer system 500, in response to the processor 503 executing an arrangement of instructions contained in main memory 505. Such instructions can be read into main memory 505 from another computer-readable medium, such as the storage device 509. Execution of the arrangement of instructions contained in main memory 505 causes the processor 503 to perform the process steps described herein. One or more processors in a multi-processing arrangement may also be employed to execute the instructions contained in main memory 505. In alternative embodiments, hard-wired circuitry may be used in place of or in combination with software instructions to implement the embodiment of the invention. Thus, embodiments of the invention are not limited to any specific combination of hardware circuitry and software.

The computer system 500 also includes a communication interface 517 coupled to bus 501. The communication interface 517 provides a two-way data communication coupling to a network link 519 connected to a local network 521. For example, the communication interface 517 may be a digital subscriber line (DSL) card or modem, an integrated services digital network (ISDN) card, a cable modem, a telephone modem, or any other communication interface to provide a data communication connection to a corresponding type of communication line. As another example, communication interface 517 may be a local area network (LAN) card (e.g. for Ethernet™ or an Asynchronous Transfer Mode (ATM) network) to provide a data communication connection to a compatible LAN. Wireless links can also be implemented. In any such implementation, communication interface 517 sends and receives electrical, electromagnetic, or optical signals that carry digital data streams representing various types of information. Further, the communication interface 517 can include peripheral interface devices, such as a Universal Serial Bus (USB) interface, a PCMCIA (Personal Computer Memory Card International Association) interface, etc. Although a single communication interface 517 is depicted in FIGS. 4A and 4B, multiple communication interfaces can also be employed.

The network link 519 typically provides data communication through one or more networks to other data devices. For example, the network link 519 may provide a connection through local network 521 to a host computer 523, which has connectivity to a network 525 (e.g. a wide area network (WAN) or the global packet data communication network now commonly referred to as the “Internet”) or to data equipment operated by a service provider. The local network 521 and the network 525 both use electrical, electromagnetic, or optical signals to convey information and instructions. The signals through the various networks and the signals on the network link 519 and through the communication interface 517, which communicate digital data with the computer system 500, are exemplary forms of carrier waves bearing the information and instructions.

The computer system 500 can send messages and receive data, including program code, through the network(s), the network link 519, and the communication interface 517. In the

Internet example, a server (not shown) might transmit requested code belonging to an application program for implementing an embodiment of the invention through the network 525, the local network 521 and the communication interface 517. The processor 503 may execute the transmitted code while being received and/or store the code in the storage device 509, or other non-volatile storage for later execution. In this manner, the computer system 500 may obtain application code in the form of a carrier wave.

The term “computer-readable medium” as used herein refers to any medium that participates in providing instructions to the processor 503 for execution. Such a medium may take many forms, including but not limited to computer-readable storage medium ((or non-transitory)—i.e., non-volatile media and volatile media), and transmission media. Non-volatile media include, for example, optical or magnetic disks, such as the storage device 509. Volatile media include dynamic memory, such as main memory 505. Transmission media include coaxial cables, copper wire and fiber optics, including the wires that comprise the bus 501. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

FIG. 6 illustrates a chip set or chip 600 upon which an embodiment of the invention may be implemented. Chip set 600 is programmed to resize a network tunnel based on criteria associated with incoming traffic to the network as described herein and includes, for instance, the processor and memory components described with respect to FIG. 5 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 600 can be implemented in a single chip. It is further contemplated that in certain embodiments the chip set or chip 600 can be implemented as a single “system on a chip.” It is further contemplated that in certain embodiments a separate ASIC would not be used, for example, and that all relevant functions as disclosed herein would be performed by a processor or processors. Chip set or chip 600, or a portion thereof, constitutes a means for performing one or more steps of resizing a network tunnel based on criteria associated with incoming traffic to the network.

In one embodiment, the chip set or chip 600 includes a communication mechanism such as a bus 601 for passing information among the components of the chip set 600. A processor 603 has connectivity to the bus 601 to execute instructions and process information stored in, for example, a memory 605. The processor 603 may include one or more processing cores with each core configured to perform independently. A multi-core processor enables multiprocessing within a single physical package. Examples of a multi-core processor include two, four, eight, or greater numbers of processing cores. Alternatively or in addition, the processor 603 may include one or more microprocessors configured in tandem via the bus 601 to enable independent execution of instructions, pipelining, and multithreading. The processor 603 may also be accompanied with one or more specialized components to perform certain processing functions and tasks such as one or more digital signal processors (DSP) 607, or one or more application-specific integrated circuits (ASIC) 609. A DSP 607 typically is configured to process real-world signals (e.g., sound) in real time independently of the processor 603. Similarly, an ASIC 609 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 600 includes merely one or more processors and some software and/or firmware supporting and/or relating to and/or for the one or more processors.

The processor 603 and accompanying components have connectivity to the memory 605 via the bus 601. The memory 605 includes both dynamic memory (e.g., RAM, magnetic disk, writable optical disk, etc.) and static memory (e.g., ROM, CD-ROM, etc.) for storing executable instructions that when executed perform the inventive steps described herein to resize a network tunnel based on criteria associated with incoming traffic to the network. The memory 605 also stores the data associated with or generated by the execution of the inventive steps.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method comprising:
determining, during a sampling period, network traffic that matches a predetermined class of service criteria of a network service provider;
determining, based on the sample, a frequency or a relevancy of network traffic matching the predetermined class of service criteria;
calculating, based on the frequency or relevancy, a minimal amount of bandwidth to reserve for tunneling subsequent network traffic associated with the predetermined class of service criteria over a network of the service provider; and
initiating, based on the calculation, a resizing of a network tunnel associated with the subsequent network traffic.

2. A method of claim 1, further comprising:
associating a weighting factor with the network traffic matching the predetermined class of service criteria; and
calculating, based on the weighting factor, the amount of bandwidth to reserve for the subsequent network traffic associated with the predetermined class of service criteria.

3. A method of claim 1, further comprising:
determining a bandwidth reservation scheme to associate with the tunnel; and
initiating the bandwidth reservation scheme,
wherein the resizing of the tunnel is based on the bandwidth reservation scheme.

4. A method of claim 1, further comprising:
comparing, during the sampling period, the network traffic against the class of service criteria,
wherein the sampling period is associated with a metering procedure of the network.

5. A method of claim 1, further comprising:
determining a class of service identifier to associate with the network traffic; and
associating the network traffic with the predetermined class of service criteria based on the class of service identifier.

6. A method of claim 1, wherein the class of service criteria defines different class of service types, a priority of the different class of service types, a port level associated with the different class of service types, a protocol associated with the different class of service types or a combination thereof.

7. A method of claim 6, wherein the weighting factor is based on the frequency or relevancy of the different class of service types.

8. A method of claim 7, wherein the weighting factor is binary.

9. A method of claim 1, wherein the sampling period is performed periodically or on demand.

10. A method of claim 1, wherein the network is a label switched network.

11. An apparatus comprising:
at least one processor; and
at least one memory including computer program code for one or more programs,
at least one memory and the computer program code configured to, with at least one processor, cause the apparatus to perform at least the following,
determining, during a sampling period, network traffic that matches a predetermined class of service criteria of a network service provider;
determining, based on the sample, a frequency or a relevancy of network traffic matching the predetermined class of service criteria;
calculating, based on the frequency or relevancy, a minimal amount of bandwidth to reserve for tunneling subsequent network traffic associated with the predetermined class of service criteria over a network of the service provider; and
initiating, based on the calculation, a resizing of a network tunnel associated with the subsequent network traffic

12. An apparatus of claim 11, further comprising:
associating a weighting factor with the network traffic matching the predetermined class of service criteria; and
calculating, based on the weighting factor, the amount of bandwidth to reserve for the subsequent network traffic associated with the predetermined class of service criteria.

13. An apparatus of claim 11, further comprising:
determining a bandwidth reservation scheme to associate with the tunnel; and
initiating the bandwidth reservation scheme,
wherein the resizing of the tunnel is based on the bandwidth reservation scheme.

14. An apparatus of claim 11, further comprising:
comparing, during the sampling period, the network traffic against the class of service criteria,
wherein the sampling period is associated with a metering procedure of the network.

15. An apparatus of claim 11, further comprising:
determining a class of service identifier to associate with the network traffic; and
associating the network traffic with the predetermined class of service criteria based on the class of service identifier.

16. An apparatus of claim 11, wherein the class of service criteria defines different class of service types, a priority of the different class of service types, a port level associated with the different class of service types, a protocol associated with the different class of service types or a combination thereof.

17. An apparatus of claim 16, wherein the weighting factor is based on the frequency or relevancy of the different class of service types.

18. An apparatus of claim 17, wherein the weighting factor is binary.

19. An apparatus of claim 11, wherein the sampling period is performed periodically or on demand.

20. An apparatus of claim 11, wherein the network is a label switched network.
